(19) United States
(12) Patent Application Publication
(10) Pub. No.: US 2013/0139519 A1
(43) Pub. Date: Jun. 6, 2013

(54) MULTI-SPOOL INTERCOOLED RECUPERATED GAS TURBINE

(71) Applicants: James Kesseli, Greenland, NH (US); James S. Nash, North Hampton, NH (US); John D. Watson, Evergreen, CO (US); Thomas Wolf, Winchester, MA (US)

(72) Inventors: James Kesseli, Greenland, NH (US); James S. Nash, North Hampton, NH (US); John D. Watson, Evergreen, CO (US); Thomas Wolf, Winchester, MA (US)

(73) Assignee: ICR TURBINE ENGINE CORPORATION, Hampton, NH (US)

(21) Appl. No.: 13/536,667

(22) Filed: Jun. 28, 2012

Related U.S. Application Data
(63) Continuation-in-part of application No. 12/115,134, filed on May 5, 2008.
(60) Provisional application No. 60/927,342, filed on May 3, 2007.

(51) Int. Cl. F02C 9/26

(52) U.S. Cl. CPC F02C 9/26
USPC 60/773; 60/39.27

(57) ABSTRACT

A method and apparatus are disclosed for a multi-spool gas turbine engine with a variable area turbine nozzle and a motor/alternator device on the highest pressure turbo-compressor spool for starting the gas turbine and power extraction during engine operation. During power down of the engine, the variable area turbine nozzle may be used in conjunction with power extraction to maintain a near constant combustor outlet temperature while controlling turbine inlet temperatures on the turbines downstream of the highest pressure turbine and controlling spool speed on the highest pressure turbine.

### CROSS-REFERENCE TO RELATED APPLICATIONS

This application is a continuation-in-part of U.S. patent application Ser. No. 12/115,134, filed May 5, 2008, which claims the benefit of U.S. provisional patent application Ser. No. 60/927,342, filed May 3, 2007. The entireties of the aforementioned applications are incorporated herein by reference.

### FIELD

Embodiments of the present invention relate generally to gas turbine engines and in particular to methods of starting a multi-spool gas turbine engine and controlling turbine inlet temperatures during power down.

### BACKGROUND

Typical multi-stage gas turbine engines are compact machines that incorporate a coaxial stack of turbines and compressors, which minimizes frontal area. The engines are, thus aerodynamic and useful as aircraft engines, for example. Another form of gas turbine engine may be composed of two or more rotating turbo-compressor assemblies that are designed to achieve progressively higher pressure ratios. A turbo-machine composed of three independent rotating assemblies or spools is shown in FIG. 1 and includes a high-pressure turbo-compressor spool 10, a low-pressure turbo-compressor spool 9, and a free turbine spool 12 appears. As also shown in FIG. 1, the high-pressure spool 10 comprises a compressor 22 and a turbine 42 that are connected by a shaft 16; the low-pressure spool 9 is composed of a compressor 45 and a turbine 11 connected by a shaft 18; and the free turbine spool 12 comprises a turbine 5 and a load device 6 connected by a shaft 24. The load device is normally an electrical generator or a vehicle drive train. A combustor 41 is used to react fuel and heated compressed air from the cold or air side of recuperator 44.

FIG. 2 shows a common method for starting a turbo-machine wherein an electro-mechanical motive power is provided to the high-pressure spool 10. A motor/clutch 13 is engaged to provide rotary power to the high-pressure spool 10. Once the high-pressure spool 10 is supplied with power and accelerated, air flow begins within the cycle which enables fuel to be admitted into the combustor where the fuel-air mixture is initiated and combusted. Hot pressurized gas from the high-pressure spool 10 is delivered to the low-pressure spool 9 and the free turbine spool 12.

There remains a need for a system and method of starting a gas turbine engine and, during power excursions of the gas turbine engine, extracting power from the engine by selectively controlling the mass flow and temperature within the engine without substantially decreasing engine efficiency. Embodiments of the present invention are generally directed to new systems and methods for starting a gas turbine engine and efficiently operating the engine especially while output power is being reduced to low power levels.

### SUMMARY

Embodiments of the present invention relate generally to turbo-machines and, more particularly, multi-spool intercooled recuperated gas turbine systems and methods of using the same. Such systems are often adapted for use as a power plant for a vehicle such as a truck, bus, or other overland vehicle. Vehicular bus or truck applications demand a very wide power range of operation. The multi-spool configuration described in this disclosure creates opportunities to control the efficiency of the engine down to a low power range. It will be appreciated that the inventions described herein have broader applications and may be used in many different environments and applications, including, for example, a stationary electric power module for distributed power generation.

It is one aspect to provide an apparatus and method for starting and/or extracting power from a gas turbine engine and a turbo-machine employing the same. In certain embodiments, the introduction of a pressurized motive fluid such as air or hydraulic fluid to a starter turbine on the high-pressure spool provides the starting power for the gas turbine. The starter turbine can be a separate turbine on the high-pressure spool or may be provided by buckets or blades machined into or otherwise formed or provided on the rotor of the compressor. In other embodiments, a motor/alternator combination is incorporated with the high-pressure spool. The addition of a motor/alternator combination to the gas turbine's high-pressure spool provides the means for both starting the gas turbine and extracting a small amount of power during engine operation. For example, the combined motor/alternator device may be coupled to the electrical system of a vehicle such that the vehicle power supply may be used to operate the motor/alternator device for starting the gas turbine and to convert a portion of the rotational power of the high-pressure spool to electrical power after the gas turbine has been started.

It is another aspect of embodiments of the present invention to increase efficiency by providing a variable area turbine nozzle between a low-pressure turbo-compressor spool and a free turbine spool. The variable area turbine nozzle, which selectively alters mass flow from the low-pressure turbo-compressor to the free turbine spool, provides the operator enhanced control over gas turbine fuel consumption.

As a gas turbine engine is powered down, primarily by reducing mass flow at an approximately constant or decreasing fuel-air ratio, the temperature drop through the high-pressure turbine is reduced because the high-pressure compressor is doing less work. Therefore, the low pressure turbine inlet temperature increases, in some instances, beyond a threshold where the metallic turbine blades could over-heat, a well-known life reduction or failure mechanism. The low pressure turbine inlet temperature increases in this way when the high pressure turbine inlet temperature is maintained substantially constant at or near its full power level. The primary way to prevent low pressure turbine over-heating comprises reducing the fuel-air ratio to reduce high pressure turbine inlet temperature. As will be appreciated by one of skill in the art, reducing the high pressure turbine inlet temperature reduces the net thermal efficiency of the engine.

By extracting power from the high-pressure spool during power-down, the high-pressure turbine continues to output a work at near-normal or increased levels and, thus, the temperature drop through the high-pressure turbine is maintained. That is, the high-pressure turbine inlet temperature can be maintained substantially at or near its maximum design value with the turbine and compressor operating near their peak efficiency islands thus maintaining engine efficiency by extracting power from the high-pressure spool. Thus it is one aspect of the present invention to provide a motor/alternator associated with the high-pressure spool. The motor/actuator provides the means for both starting the gas turbine and extracting a small amount of power during engine operation. By reducing fuel consumption with the variable area turbine nozzle and extracting power using the motor/alternator, the low pressure turbine inlet temperature can be significantly reduced and/or maintained below a predetermined threshold while the high-pressure turbine inlet temperature is maintained at about its highest allowable operating level.

An engine is disclosed comprising: a combustor, a fuel system operable to provide an amount of fuel to the combustor to provide a selected combustor output temperature, a higher pressure spool having a higher pressure compressor, a higher pressure turbine, and a first rotatable shaft rotatably coupling the higher pressure compressor and the higher pressure turbine on a first pair of bearings wherein the higher pressure turbine delivers a first reduced pressure and temperature gas flow to one or more lower pressure spools, one or more lower pressure spools, at least one of which has a lower pressure compressor and a lower pressure turbine rotatably connected by a second rotatable shaft, a primary power takeoff from at least one of the higher pressure spool and one of the one or more lower pressure spools, wherein the power takeoff delivers a first power level, a variable area nozzle upstream of a free power turbine, wherein the mass flow controlled by the variable area nozzle is a first mass flow to the free power turbine, a combined motor and alternator device as part of said higher pressure spool operable, in a first mode, to drive the first rotatable shaft for starting the engine and, in a second mode, to convert rotational energy of the first rotatable shaft to electrical energy and, in a third mode, to free wheel, and a control system operable to reduce power from the power takeoff from the first power level to a second lower power level while substantially providing at least one of a selected engine efficiency, a selected fuel-air ratio, a selected combustor exit temperature, a selected fuel consumption level of the engine and a selected higher pressure spool speed by using the variable area nozzle to reduce the first mass flow to a second lower mass flow and by operating the combined motor and alternator device in the second mode, wherein the inlet temperatures to the one or more lower pressure turbines are maintained below selected threshold temperatures.

A method is disclosed comprising: (a) providing a gas turbine engine comprising a combustor, one or more turbo-compressor spools, at least one power turbine, a combined motor and alternator device in mechanical communication with the one or more turbo-compressor spools, and a variable area nozzle positioned upstream of the at least one power turbine, wherein, during a first time interval, a first rate of fuel flow is to the combustor and a first rate of mass flow of the combusted gas exits the combustor, (b) during a second time interval, reducing a first rate of fuel flow to the combustor to a second rate of fuel flow to the combustor, the first rate of fuel flow being greater than the second rate of fuel flow, (c) during the second time interval, reducing, by the variable area nozzle, a first rate of mass flow of the combusted gas exiting the combustor to a second rate of mass flow of the combusted gas existing the combustor, the first rate of mass flow being greater than the second rate of mass flow, and (d) during the second time interval, extracting electrical energy with the combined motor and alternator device operating in an electrical energy generating mode, thereby substantially maintaining the temperature of the combusted gas exiting the combustor, maintaining the higher pressure spool speed below a selected threshold speed and maintaining the inlet temperature to the one or more lower pressure turbines below selected threshold temperatures.

Another engine is disclosed comprising: a combustor, a fuel system operable to provide an amount of fuel to the combustor to provide a selected combustor output temperature, a higher pressure spool having a higher pressure compressor, a higher pressure turbine, and a first rotatable shaft rotatably coupling the higher pressure compressor and the higher pressure turbine on a first pair of bearings wherein the higher pressure turbine delivers a first reduced pressure and temperature gas flow to one or more lower pressure spools, one or more lower pressure spools, at least one of which has a lower pressure compressor and a lower pressure turbine rotatably connected by a second rotatable shaft, a primary power takeoff from at least one of the higher pressure spool and one of the one or more lower pressure spools, wherein the power takeoff delivers a first power level, a variable area nozzle upstream of a free power turbine, wherein the mass flow controlled by the variable area nozzle is a first mass flow to the free power turbine, a combined motor and alternator device as part of said higher pressure spool operable, in a first mode, to drive the first rotatable shaft for starting the engine and, in a second mode, to convert rotational energy of the first rotatable shaft to electrical energy and, in a third mode, to free wheel, and a control system operable to reduce power from the power takeoff from the first power level to a second lower power level while substantially providing at least one of a selected engine efficiency, a selected fuel-air ratio, a selected combustor exit temperature, a selected fuel consumption level of the engine and a selected higher pressure spool speed by using the variable area nozzle to reduce the first mass flow to a second lower mass flow and by operating the combined motor and alternator device in the second mode, wherein the inlet temperatures to the one or more lower pressure turbines are reduced below the inlet temperatures to the one or more lower pressure turbines when operating the combined motor and alternator device in the third mode.

A method is disclosed comprising: (a) providing a gas turbine engine comprising a combustor, one or more turbo-compressor spools, at least one power turbine, a combined motor and alternator device in mechanical communication with the one or more turbo-compressor spools, and a variable area nozzle positioned upstream of the at least one power turbine, wherein, during a first time interval, a first rate of fuel flow is to the combustor and a first rate of mass flow of the combusted gas exits the combustor; (b) during a second time interval, reducing a first rate of fuel flow to the combustor to a second rate of fuel flow to the combustor, the first rate of fuel flow being greater than the second rate of fuel flow; (c) during the second time interval, reducing, by the variable area nozzle, a first rate of mass flow of the combusted gas exiting the combustor to a second rate of mass flow of the combusted gas existing the combustor, the first rate of mass flow being greater than the second rate of mass flow; and (d) during the second time interval, extracting electrical energy with the combined motor and alternator device operating in an electrical energy generating mode, thereby reducing the inlet temperatures to the one or more lower pressure turbines below the inlet temperatures to the one or more lower pressure turbines when operating the combined motor and alternator device in the third mode.

Another method is disclosed comprising providing a gas turbine engine comprising a combustor, one or more turbo-compressor spools, at least one power turbine, a generator device in mechanical communication with the one or more turbo-compressor spools, and a variable area nozzle positioned upstream of the at least one power turbine, wherein, during a first time interval, a first rate of fuel flow is to the combustor and a first rate of mass flow of the combusted gas exits the combustor; during a second time interval, reducing a first rate of fuel flow to the combustor to a second rate of fuel flow to the combustor, the first rate of fuel flow being greater than the second rate of fuel flow; during the second time interval, reducing, by the variable area nozzle, a first rate of mass flow of the combusted gas exiting the combustor to a second rate of mass flow of the combusted gas existing the combustor, the first rate of mass flow being greater than the second rate of mass flow; and during the second time interval, extracting electrical energy with the generator device operating in an electrical energy generating mode, thereby maintaining the speed of one or more turbo-compressor spools below a selected value.

Yet another method is disclosed providing a gas turbine engine comprising a combustor, a fuel system, a control system, one or more turbo-compressor spools, at least one power turbine, a motor/generator device in mechanical communication with the one or more turbo-compressor spools, and a variable area nozzle positioned upstream of the at least one power turbine, wherein, during a first time interval, the following is true:

a first power is output by the at least one power turbine;

a first rate of fuel flow is sent to the combustor by the fuel system;

a first rate of mass flow is controlled by the variable area nozzle;

a first amount of auxiliary power is extracted from the motor/generator device wherein the first amount of auxiliary power may be zero;

the combusted gas exits the combustor at a selected combustor output temperature; and

an engine efficiency is established by maintaining a selected combustor output temperature; and wherein, during a second time interval, the following is true:

a second power is output by the at least one power turbine, the second power output being less than the first power output;

a second rate of fuel flow is sent to the combustor by the fuel system, the second rate of fuel flow being less than the first rate of fuel flow

a second rate of mass flow is controlled by the variable area nozzle, the second rate of mass flow being less than the first rate of mass flow; and

a second amount of auxiliary power is extracted from the motor/generator device wherein the second amount of auxiliary power is greater than the first amount of auxiliary power.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The invention may take form in various components and arrangements of components, and in various steps and arrangements of steps. The drawings are only for purposes of illustrating some embodiments and are not to be construed as limiting the invention.

FIG. 1 depicts a turbo machine of the prior art composed of three independent spools, two nested turbo compressor spools, and one free turbine spool connected to a load device.

FIG. 2 illustrates an apparatus and method for starting the turbo machine of the prior art comprised of providing electro-mechanical motive power to the high spool turbo compressor.

FIG. 3 illustrates an apparatus and method for starting a gas turbine that includes providing pneumatic power to the high spool turbo compressor.

FIG. 4 illustrates an apparatus and method of integrating an air starter turbine into a compressor impeller.

FIG. 5 illustrates an electric motor/generator combination associated with one turbo compressor spool of a gas turbine engine.

FIG. 6 illustrates yet another variation on the integrated high spool motor generator of embodiments of the present invention.

FIG. 7 illustrates an apparatus and method for combining a high speed permanent magnetic alternator into the shaft of a turbo compressor spool.

FIG. 8 is a graphical representation of thermal efficiency of a gas turbine engine versus engine output power.

FIG. 9 is a flow chart illustrating control of low pressure turbine inlet temperature.

To assist in the understanding of one embodiment of the present invention the following list of components and associated numbering found in the drawings is provided herein:

| | |
|---|---|
| Starter Turbine | 4 |
| Free Power Turbine | 5 |
| Load | 6 |
| Low-Pressure Spool | 9 |
| High-Pressure Spool | 10 |
| Low-Pressure Turbine | 11 |
| Motor/Clutch | 13 |
| Free Power Turbine Spool | 12 |
| Shaft from HPC to HPT | 16 |
| Electric Motor/Alternator | 17 |
| Shaft from LPC to LPT | 18 |
| Starter Fluid Container | 20 |
| Conduit | 21 |
| High-Pressure Compressor | 22 |
| Conduit | 23 |
| Shaft from FPT to Load | 24 |
| Valve | 25 |
| Starter Motor | 27 |
| Turbine Buckets | 30 |
| Turbo-Compressor Shaft | 31 |
| Air Bearings | 32 |
| Air Supply Conduit | 33 |
| Compressor Impeller | 35 |
| Electric Stator Components | 37 |
| Magnetized Alternator/Motor Assembly | 38 |
| High-Pressure Turbine Rotor | 39 |
| Variable Area Nozzle | 40 |
| Combustor | 41 |
| High-Pressure Turbine | 42 |
| Recuperator | 44 |
| Low-Pressure Compressor | 45 |
| Main High-Pressure Spool Shaft Bearings | 91 |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

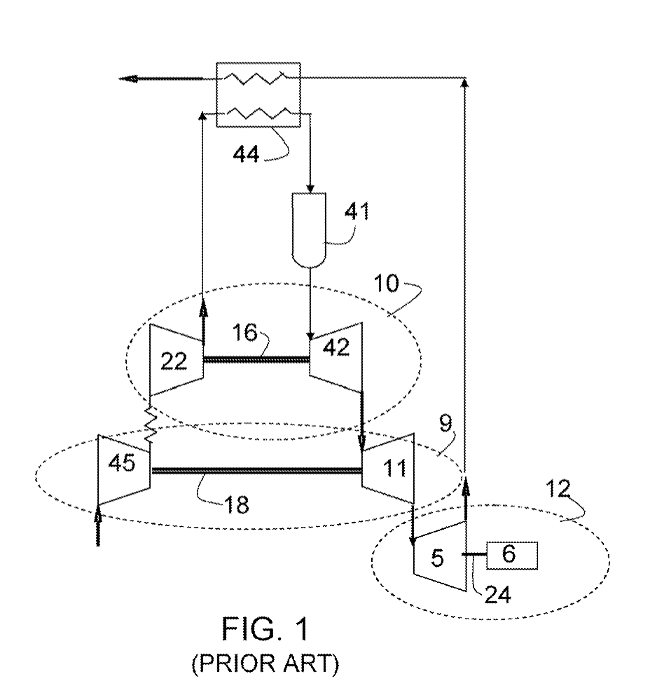

Referring to the drawings, wherein like reference numerals refer to like or analogous components throughout the several views, FIG. 1 is schematic of the component architecture of a prior art multi-spool gas turbine engine. Typically, air is ingested into a low pressure compressor 45. The outlet of the low pressure compressor 45 passes through an intercooler which removes a portion of heat from the gas stream at approximately constant pressure. The gas then enters a high pressure compressor 22. The outlet of high pressure compressor 22 passes through a recuperator 44 where a significant portion of the heat from the exhaust gas is transferred, at approximately constant pressure, to the gas flow from high pressure compressor 22. The further heated gas from recuperator 44 is then directed to a combustor 41 where a fuel is reacted or burned, adding a small mass of fuel and substantial energy to the gas flow at approximately constant pressure. The gas emerging from combustor 41 then enters a high pressure turbine 42 where work is done by high pressure turbine 42 to operate high pressure compressor 22. The gas from high pressure turbine 42 then enters a low pressure turbine 11 where work is done by low pressure turbine 11 to operate low pressure compressor 45. The gas from low pressure turbine 11 then enters a free power turbine 5. The shaft 24 of free power turbine 5, in turn, drives a transmission 6 which may be an electrical, mechanical or hybrid transmission for a vehicle. Alternately, the shaft of the free power turbine 5 can drive an electrical generator or alternator. This engine design is described, for example, in U.S. patent application Ser. No. 12/115,134 filed May 5, 2008, entitled “Multi-Spool Intercooled Recuperated Gas Turbine”, which is incorporated herein by this reference. Low pressure compressor 45 is shown connected to low pressure turbine 11 by shaft 18 and these three components form low pressure spool 9. High pressure compressor 22 is shown connected to high pressure turbine 42 by shaft 16 and these three components form high pressure spool 10. Free power turbine 5 and load 6 are connected by shaft 24 and these three components form free power spool 12.

Variations of this engine architecture may include a reheater and/or thermal energy storage devices such as described, for example, in U.S. patent application Ser. No. 13/175,564, entitled “Improved Multi-Spool Intercooled Recuperated Gas Turbine” and U.S. patent application Ser. No. 12/777,916, entitled “Gas Turbine Energy Storage and Conversion System”, both of which are incorporated herein by reference.

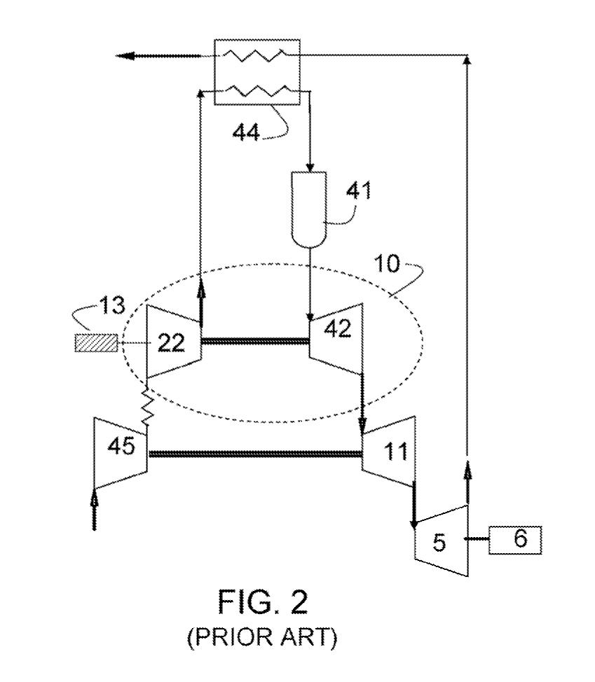

FIG. 2 shows the same engine architecture as FIG. 1 except a starter motor 13 is shown connected to high pressure compressor 22.

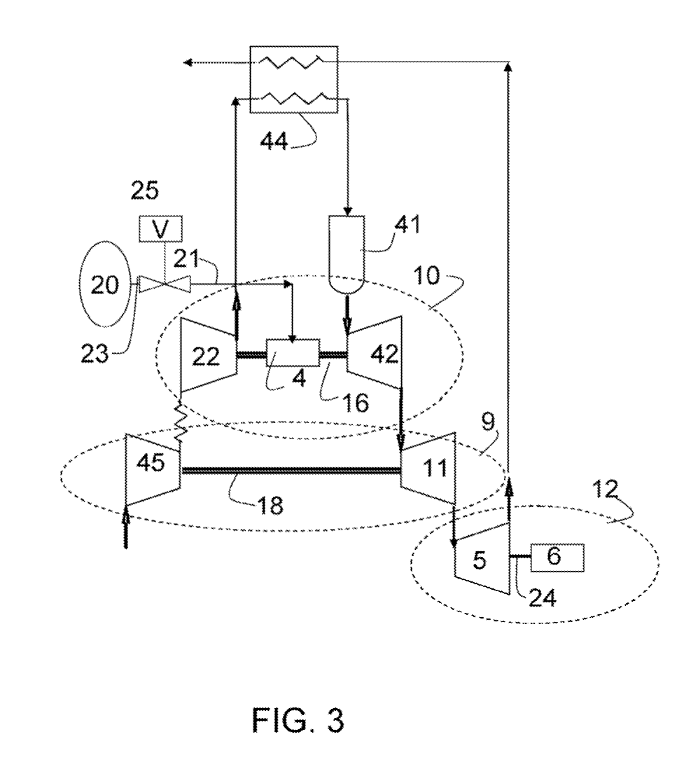

FIG. 3 illustrates an apparatus and method of starting a multi-spool gas turbine which may generally be of the type appearing in FIG. 1, by providing pneumatic or hydraulic power to a high-pressure turbo compressor spool 10. In certain embodiments, a vessel 20 contains a high pressure gas, such as air, that is delivered through conduits 21 and 23 to a starter turbine 4. The conduits 21 and 23 have a control valve 25 therebetween. The starter turbine may be a gas turbine affixed to a shaft 16 of the high-pressure turbo compressor spool 10.

In alternative embodiments, the conduit 23, valve 25, and conduit 21 may supply hydraulic fluid as the motive fluid to the starter turbine 4, which may alternatively be a hydraulic turbine affixed to the shaft 16 of the turbo compressor spool 10. It is preferable to employ air as the motive fluid for the turbine 4 rather than hydraulic fluid in those embodiments wherein the turbine 4 is supported on air bearings. Likewise, it is preferable to employ conventional, oil lubricated bearings in place of air bearings when the motive fluid is a hydraulic fluid.

The valve 25 may be operated via a controller that selectively opens the valve to permit passage of the pressurized fluid from the container 20 to the starter turbine 4 in response to a control signal, such as a signal to start the gas turbine engine. The starter turbine 4 may be affixed or integrated with the turbo compressor spool 10 without the need for additional bearings or couplings. In operation, the motive fluid delivered to the turbine 4 imparts angular momentum to rotate the high-pressure turbo compressor spool 10 to initiate airflow therethrough. Also, as the high-pressure turbo-compressor spool 10 rotates, it creates air flow within the low-pressure turbo-compressor spool 9 and within the free power spool 12 of the turbo machine.

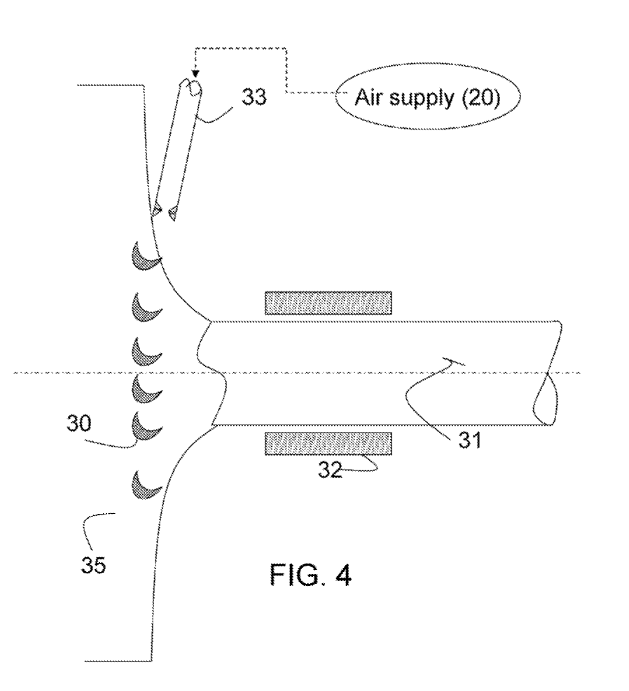

Referring now to FIG. 4, there is shown a partial sectional view of an exemplary embodiment of the present invention wherein the turbine 4 is and air or gas turbine supported on a shaft 31 which, in turn, is rotatably supported on air bearings 32. The turbine 4 may include a compressor impeller 35 of the compressor 22 (See FIG. 3) by milling or otherwise forming or providing small turbine buckets 30 on or in the back face of the compressor impeller 35. The addition of the turbine buckets 30 enables the compressor 35 to more productively use the high-pressure air supplied from the air supply 20 and an air nozzle 33. As the air enters the compressor 35, the turbine buckets 30 catch the air and turn the turbo compressor shaft 31 to start the high-pressure turbine.

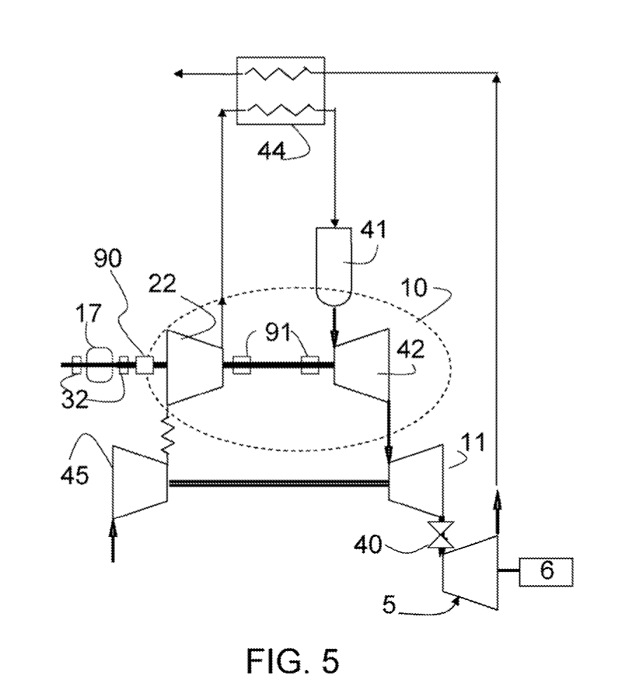

FIG. 5 illustrates a further embodiment of the present invention wherein an electric motor/alternator combination 17 is combined with the high-pressure turbo compressor spool 10 similar to that described above. The motor/alternator combination 17 provides a means for starting the gas turbine as well as the ability to extract a small amount of power (for example, less than about 10% of the full power rating of the gas turbine) during engine operation. This relatively small amount of extracted power also provides a means of controlling the speed of high-pressure turbo compressor spool 10 while the engine operates at minimum power near its idle point. The relatively small amount of electric power generated is well suited for vehicular auxiliary electric system loads which are independent of drive power needed for the vehicle.

Also shown in FIG. 5, is an exemplary method of power take off for a single spool gas turbine engine, which requires the coupling of the motor/alternator 17 at the inlet end of a compressor shaft. Single spool gas turbines, configured as a turbo compressor/alternator assembly require a mechanical coupling to connect the turbo compressor 10, operating on its main bearings 91, to a alternator 17, operating on its bearings 32. In such an embodiment the turbo compressor 10 and the alternator 17 are installed on their own bearings 91 and 32, respectively, with a coupling 90 employed to connect the two rotating machines. In certain configurations, the coupling 90 may incorporate a mechanical clutch or mechanism typically used to engage and disengage the starting device. As can be appreciated, the motor/alternator device 17 can be operated in a first mode as a starter motor for the gas turbine, in a second mode to extract power from the working fluid, and in a third mode “free-wheeling” when disengaged.

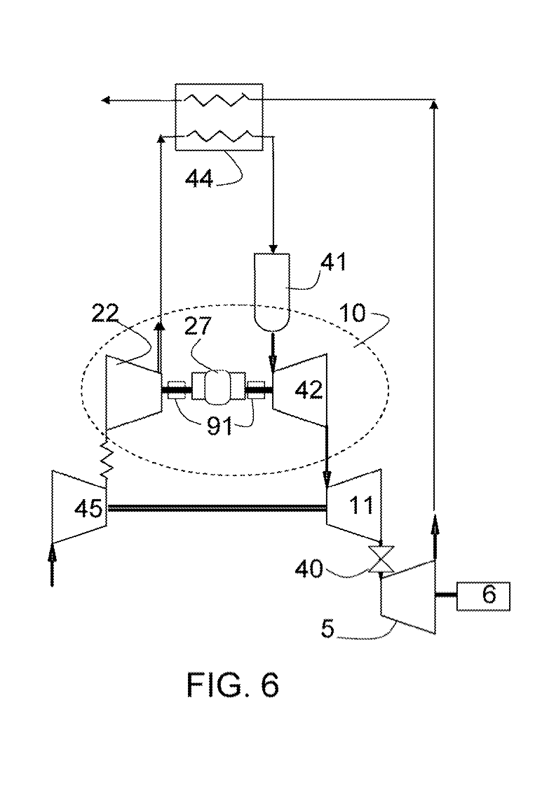

In the present disclosure, referring to FIG. 6, due to the small fraction of the turbine power devoted to the alternate load, the size of the alternator 27 is relatively small when compared to alternators driven by gas turbines. For this reason, a compact shaft-speed alternator may be installed on the turbine alternator spool 10 without separate bearings and couplings. For example, a samarium-cobalt type permanent magnet alternator is small enough to fit within a hollow portion of the shaft, either between the compressor 22 and turbine 42 or overhung from the compressor inlet. FIG. 6 illustrates a variation on the integrated high spool motor/generator device, incorporating a compact motor/alternator combination 27 between the turbine 42 and the compressor 22. The terms “generator” and “alternator” are used interchangeably herein unless specifically stated otherwise.

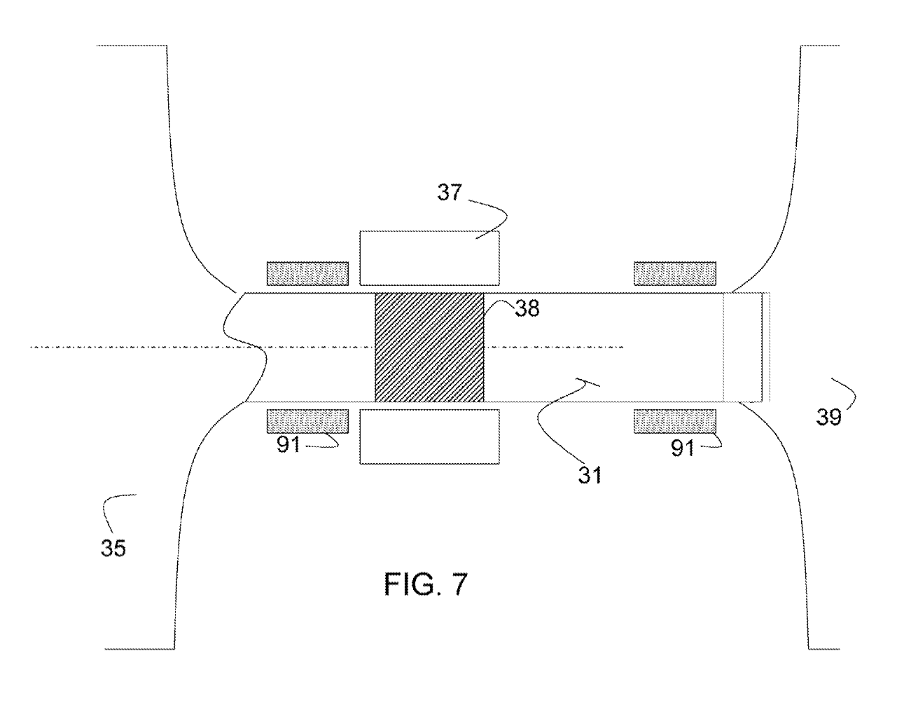

FIG. 7 shows an alternative embodiment integrating a magnetized motor/alternator 38 into the high-pressure spool turbo-compressor spool 10. A hollow shaft 31, which connects a compressor rotor 35 and a turbine rotor 39, rotates on main bearings 91. Because the accessory load absorbed by the motor/alternator 38 rotor and starting power required from the motor/alternator 38 are small, the magnetized rotor can be contained inside the hollow shaft 31. Electrical stator components 37 surround the magnetized alternator/motor rotor 38 assembly. In an alternative embodiment, a mechanical configuration employing these components, may be arranged with the motor/alternator 38 and the electrical stator components 37 in front of or integral with compressor 35, employing a single pair of main bearings 91.

Exemplary embodiments of the present invention showing the location of a variable area turbine nozzle 40 are seen in FIGS. 3, 5 and 6. Although the gas turbine embodiments herein may operate with a conventional fixed geometry turbine nozzle, the use of a variable area turbine nozzle 40 is advantageous in that it enables an additional control to lower fuel consumption by controlling the rate of flow of air to the turbine 5 of the free turbine spool. The ability to lower fuel consumption in this way allows the embodiments of the present invention to operate at higher efficiency than would otherwise be possible.

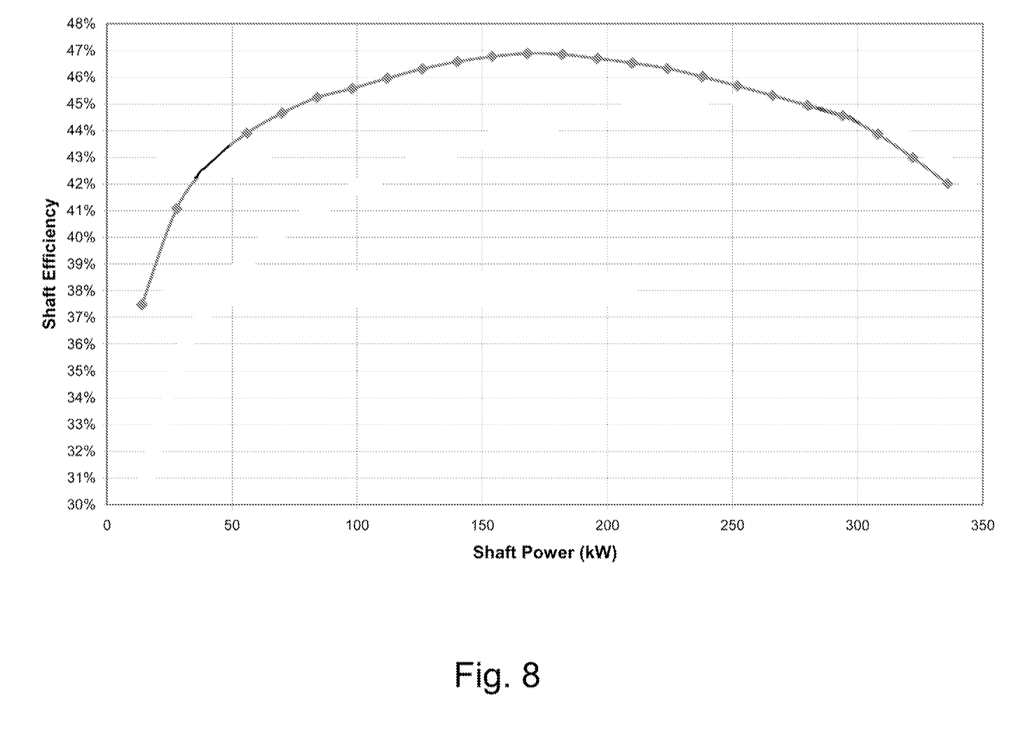

For example, the performance of the gas turbine engine as shown in FIG. 5 is defined by a set of engine thermal efficiency versus shaft power output curves that range from zero to full power output. FIG. 8 shows typical efficiency versus power curve for a gas turbine engine with a full power rating of about 340 kW. A combustor output temperature is associated with each point the efficiency versus power curve. In the three spool engine of FIG. 5, the combustor output temperature is substantially the same as the high pressure turbine inlet temperature. It is desirous to maintain the high pressure turbine inlet temperature substantially constant at its highest allowable value over most of the power range so as to maintain the highest possible engine efficiency. This can be accomplished by controlling the fuel flow and mass flow in the engine while maintaining an approximately constant or even decreasing fuel-air ratio. These latter steps must be carried out while respecting the operating points on the compressor and turbine maps. Fuel-air ratio may decrease during power down as the turbines become less efficient and flow temperature exiting the free power turbine and entering the hot side of the recuperator increases, thereby increasing the heat transfer to the cold side of the recuperator which, in turn, increases the preheating of the air entering the combustor.

A compressor map is typically a graph showing compressor pressure ratio plotted versus corrected flow mass rate wherein a surge limit curve, a choke limit curve and an selected operating curve are typically shown. The map may also show various curves of constant compressor speeds. A companion compressor map may also be a graph showing compressor isentropic efficiency plotted versus corrected flow mass rate and the map may also show various curves of constant compressor speeds and the selected operating curve.

A typical turbine map is a graph showing corrected flow mass rate plotted versus turbine pressure ratio in the form of curves of constant speeds. A companion turbine map may also be a graph showing isentropic efficiency plotted versus turbine pressure ratio in the form of curves of constant speeds.

For turbo-compressor spools as shown herein, compressor speeds are typically the same as their counterpart turbine speeds. Also the work extracted from the flow by the turbine is equal to the work done by the compressor plus turbo-compressor spool bearing losses. The mass flow rate through the turbine is equal to the mass flow rate through compressor plus the fuel flow rate added in the combustor. As can be appreciated, there may be other forms of compressor and turbine maps.

The compressors and turbines are maintained preferably within the regions between surge and choke. This requires monitoring all compressor and turbine speeds, all compressor and turbine pressure ratios, and making constant reference to the compressor and turbine maps. Changes to the fuel-air ratio in the combustor are typically used to compensate for variances in the compressor and turbine efficiencies and in the recuperator effectiveness, all of which are functions of mass flow.

The gas flow in a modern gas turbine engine can be computed by assuming the inlet air and combustion products behave as ideal gases in which enthalpies and constant pressure heat capacities are functions only of temperature. This means that the combustor output temperature is, to a first order, dependent only on fuel-air ratio and is, for practical purposes, not sensitive to combustor pressure. During power-down, the heat transfer through the recuperator 44 varies because of thermal inertia and the temperature increase in the flow through the hot side of the recuperator. Therefore, fuel flow can be a useful control parameter and maintaining an approximately constant or slowly decreasing fuel-air ratio can be important to maintaining an approximately constant high pressure turbine inlet temperature.

To design a high efficiency engine, many components of the high-pressure turbine can be made from ceramics so that the rotor blades, for example, can withstand the required high turbine inlet temperatures without sacrificing cooling air. Normally, the low pressure turbine inlet temperatures are low enough that the low pressure turbine rotor can be made from a metal such as a high temperature nickel-steel alloy, for example.

As the engine is powered down, primarily by reducing mass flow at an approximately constant or slightly decreasing fuel-air ratio, the temperature drop through the high-pressure turbine is reduced because the high-pressure compressor is doing less work. As can be appreciated, when the high pressure turbine inlet temperature is maintained substantially constant at or near its full power level during power down, the low pressure turbine inlet temperature increases. The low pressure turbine inlet temperature may increase beyond the threshold where its metallic blades over-heat. Such over-heating can cause blade warp, creep, and eventually melting of the blades. As one of skill in the art will appreciate, turbine blade failure can cause catastrophic engine failure.

In the past, when the low pressure turbine inlet temperature threshold is approached, the fuel-air ratio is reduced to reduce high pressure turbine inlet temperature, which is typically the primary way to prevent low pressure turbine over-heating. As can be appreciated, engine thermal efficiency is also reduced as high pressure turbine inlet temperature is reduced.

If power can be extracted from the high-pressure spool during power-down, then the high-pressure turbine will be forced to do more work and the temperature drop through the high-pressure turbine is reduced. Therefore, the high pressure turbine inlet temperature can be maintained at or near its maximum design value longer and engine efficiency can remain high. Power can be extracted during power-down by the high-pressure spool using a motor/generator such as shown in FIG. 5. The extracted power can be used for auxiliary power and/or to charge an energy storage system, such as, for example, a battery or a thermal energy storage device. This extracted power is useful and is typically added to the free power shaft output power to determine overall engine efficiency.

By reducing fuel consumption with the variable area turbine nozzle and using the motor/alternator in power extraction mode, the inlet temperature to the low pressure turbine can be reduced and maintained below a selected threshold while maintaining a high temperature at the high pressure turbine inlet.

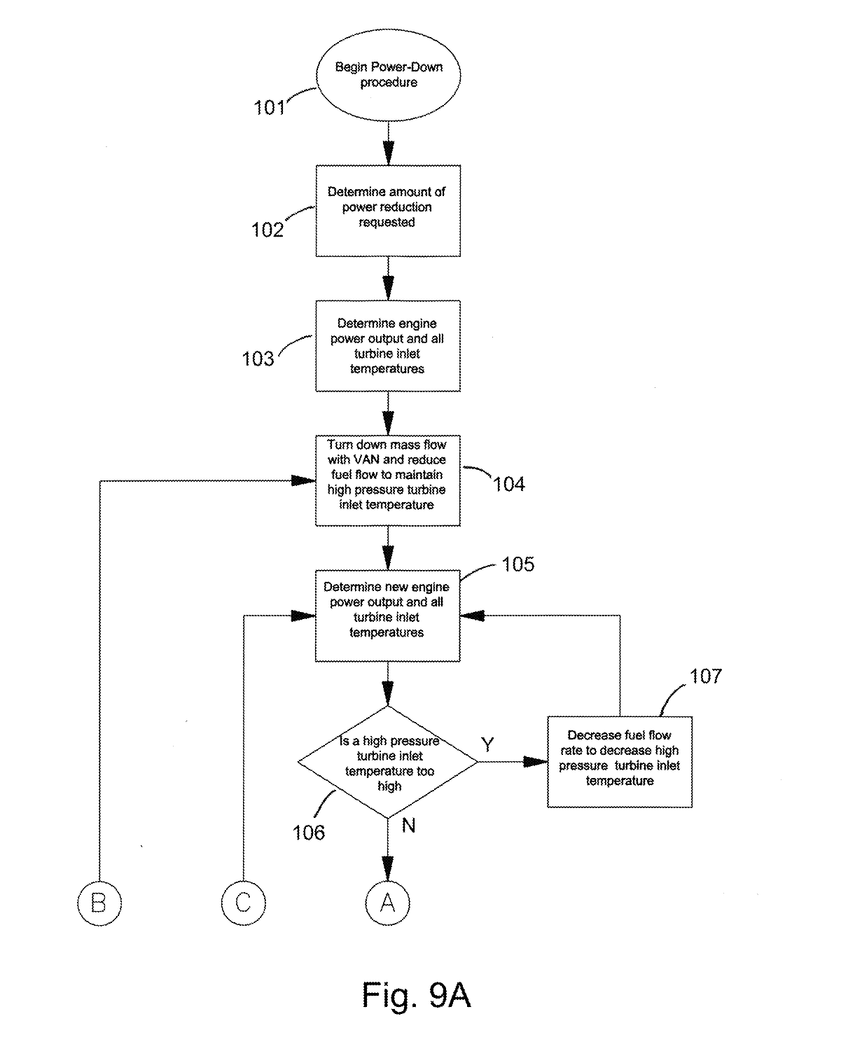

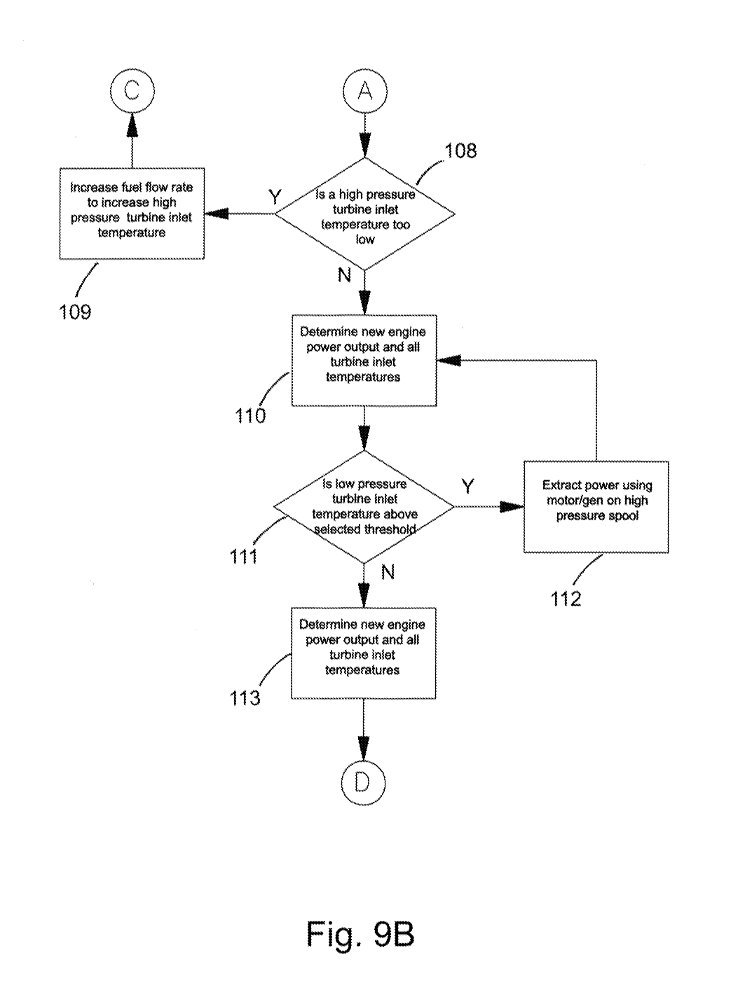

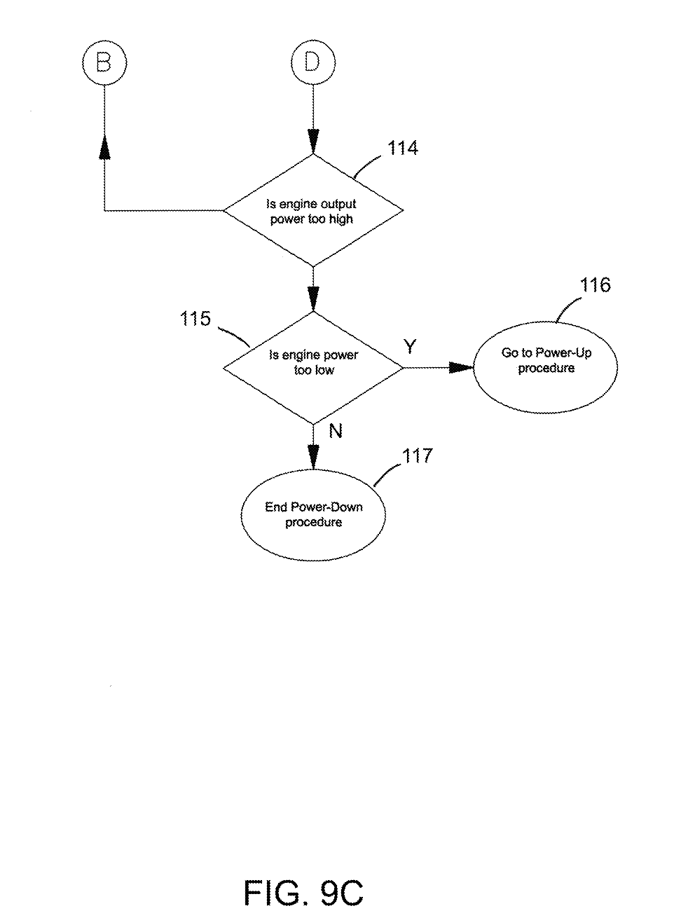

FIG. 9 illustrates an example of a high-level control procedure for using power extraction from the high-pressure spool along with a variable area nozzle (“VAN”) to control the low pressure turbine inlet temperature during engine power-down. The power-down procedure of one embodiment is initiated automatically by microprocessor executable instructions stored on a tangible computer readable (storage) medium by a microprocessor determining the amount of power reduction requested by the operator 102, and determining the power output of the engine, and all turbine inlet temperatures by measurement or calculation. Power output may be measured by measuring free power turbine output shaft speed and torque if the load is mechanical or by the output volts and current if the load is electrical. Turbine inlet temperatures may be measured by thermocouples or thermoresistors for example. Alternately, the microprocessor can determine turbine inlet temperatures by measuring all compressor and turbine speeds, pressure ratios, mass flow, and VAN setting and can refer to compressor and turbine maps. These first determinations 103 characterize the engine at the initial power level before power-down begins.

In response, the microprocessor reduces engine output power 104 by a prescribed amount using the VAN to reduce flow mass through the engine while also reducing fuel flow rate such that high pressure turbine inlet temperature remains approximately constant. The power output of the engine and all turbine inlet temperatures 105. When microprocessors again determines the high pressure turbine inlet temperature is too high 106, then the microprocessor reduces fuel flow 107 until high pressure turbine inlet temperature is reduced to within an acceptable range of its desired level. When high pressure turbine inlet temperature is too low 108, the microprocessor increases fuel flow 109 until high pressure turbine inlet temperature is restored to within an acceptable range of its desired level. These procedures are repeated by the microprocessor until high pressure turbine inlet temperature is within an acceptable value.

The microprocessor again determines the power output of the engine and all turbine inlet temperatures 110 When the low pressure turbine inlet temperature is above its design threshold 111, then the microprocessor causes power to be extracted by the motor/generator device on the high-pressure spool 112. When the low pressure turbine inlet temperature is below its design threshold 111, the microprocessor again determines power output of the engine and all turbine inlet temperatures 113. When engine output power is higher 114 than the requested power level, then the microprocessor returns the power-down procedure to step 104. When engine output power is lower 115 than the requested power level, then the microprocessor terminates the power-down procedure and sends control to the power-up control procedure 116. Once the microprocessor determines engine output power to be within an acceptable range of the initially requested power level, the microprocessor terminates power-down procedure 117.

The power-down procedure may be carried out not only under computer control but by a combination of computer and human control or human control only.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

What is claimed is:

1. An engine, comprising:
a combustor;
a fuel system operable to provide an amount of fuel to the combustor to provide a selected combustor output temperature;
a higher pressure spool having a higher pressure compressor, a higher pressure turbine, and a first rotatable shaft rotatably coupling the higher pressure compressor and the higher pressure turbine on a first pair of bearings wherein the higher pressure turbine delivers a first reduced pressure and temperature gas flow to one or more lower pressure spools;
one or more lower pressure spools, at least one of which has a lower pressure compressor and a lower pressure turbine rotatably connected by a second rotatable shaft;
a primary power takeoff from at least one of the higher pressure spool and one of the one or more lower pressure spools, wherein the power takeoff delivers a first power level;
a variable area nozzle upstream of a free power turbine, wherein the mass flow controlled by the variable area nozzle is a first mass flow to the free power turbine;
a combined motor and alternator device as part of the higher pressure spool operable, in a first mode, to drive the first rotatable shaft for starting the engine and, in a second mode, to convert rotational energy of the first rotatable shaft to electrical energy and, in a third mode, to free wheel; and
a control system operable to reduce power from the power takeoff from the first power level to a second lower power level while substantially providing at least one of a selected engine efficiency, a selected fuel-air ratio, a selected combustor exit temperature, a selected fuel consumption level of the engine and a selected higher pressure spool speed using the variable area nozzle to reduce the first mass flow to a second lower mass flow and by operating the combined motor and alternator device in the second mode, wherein the inlet temperatures to the one or more lower pressure turbines are maintained below selected threshold temperatures.

2. The engine of claim 1, wherein the combined motor and alternator device is electrically coupled to an electrical system of a vehicle and wherein the engine comprises an intercooler positioned between the higher pressure spool and the one or more lower pressure spools and a recuperator positioned to transfer heat from an exhaust gas output by a free power turbine to a high pressure gas output by the higher pressure compressor.

3. The engine of claim 1, further comprising:
a heat exchanger; and
said free turbine delivering a third reduced pressure airflow to the heat exchanger for transferring heat from the third reduced pressure airflow to the high pressure airflow from the high-pressure compressor.

4. The engine of claim 1, wherein the variable area nozzle is at least one of downstream of the higher pressure spool and downstream of the one or more lower pressure spools.

5. The engine of claim 1, wherein the control system reduces power from the power takeoff from the first power level to a second lower power level while substantially providing the selected engine efficiency by using the variable area nozzle to reduce the first mass flow to the second lower mass flow.

6. The engine of claim 1, wherein the control system reduces power from the power takeoff from the first power level to the second lower power level while substantially providing the selected fuel-air ratio of the engine by using the variable area nozzle to reduce the first mass flow to the second lower mass flow.

7. The engine of claim 1, wherein the control system reduces power from the power takeoff from the first power level to the second lower power level while substantially providing the selected fuel consumption level of the engine by using the variable area nozzle to reduce the first mass flow to the second lower mass flow.

8. The engine of claim 1, wherein the control system reduces power from the power takeoff from the first power level to the second lower power level while substantially providing the selected combustor exit temperature by using the variable area nozzle to reduce the first mass flow to the second lower mass flow.

9. The engine of claim 1, wherein the control system reduces power from the power takeoff from the first power level to the second lower power level while substantially providing the a selected higher pressure spool rpm by using the variable area nozzle to reduce the first mass flow to the second lower mass flow.

10. A method, comprising:
(a) providing a gas turbine engine comprising a combustor, one or more turbo-compressor spools, at least one power turbine, a combined motor and alternator device in mechanical communication with the one or more turbo-compressor spools, and a variable area nozzle positioned upstream of the at least one power turbine, wherein, during a first time interval, a first rate of fuel flow is to the combustor and a first rate of mass flow of the combusted gas exits the combustor;
(b) during a second time interval, reducing a first rate of fuel flow to the combustor to a second rate of fuel flow to the combustor, the first rate of fuel flow being greater than the second rate of fuel flow;
(c) during the second time interval, reducing, by the variable area nozzle, a first rate of mass flow of the combusted gas exiting the combustor to a second rate of mass flow of the combusted gas existing the combustor, the first rate of mass flow being greater than the second rate of mass flow; and
(d) during the second time interval, extracting electrical energy with the combined motor and alternator device operating in an electrical energy generating mode, thereby substantially maintaining the temperature of the combusted gas exiting the combustor, maintaining the higher pressure spool speed below a selected threshold speed and maintaining the inlet temperature to the one or more lower pressure turbines below selected threshold temperatures.

11. The method of claim 10, wherein the combined motor and alternator device imparts rotation including electrically coupling the combined motor and alternator device to a power supply of a vehicle; and
after starting the engine, using the combined motor and alternator device to convert rotational energy of the rotatable shaft to electrical energy.

12. The method of claim 10, wherein, during engine operation, the combined motor and alternator extracts less than about 10% of the full power rating of the engine.

13. A non-transient computer-readable medium comprising microprocessor executed instructions that, when executed, perform steps (b), (c), and (c) of claim 10

14. The engine of claim 13, wherein the engine comprises a free turbine spool, and further comprising:
a heat exchanger; and
the free turbine spool delivering a third reduced pressure gas flow to the heat exchanger for transferring heat from the third reduced pressure gas flow to the gas flow from the higher pressure compressor.

15. The engine of claim 14, wherein the load device is connected to the free turbine, the load device being at least one of an alternator and a geared transmission.

16. The engine of claim 15, wherein the combined motor and alternator device is supported on the first rotatable shaft and wherein the first and second rotatable shafts are not axially aligned with respect to one another.

17. The engine of claim 16, further comprising:
air bearings supporting the combined motor and alternator device on the first rotatable shaft.

18. The engine of claim 13 wherein the combined motor and alternator device includes a magnetic rotor embedded within the first rotatable shaft.

19. The engine of claim 13, wherein the combined motor and alternator device is disposed within a bearing system located on the first rotatable shaft between the higher pressure turbine and the higher pressure compressor.

20. The engine of claim 13, wherein the combined motor and alternator device is coupled to the higher pressure compressor.

21. The engine of claim 13, wherein the combined motor and alternator device is electrically coupled to an electrical system of a vehicle and wherein the engine comprises an intercooler positioned between the higher pressure spool and the one or more lower pressure spools and a recuperator positioned to transfer heat from an exhaust gas output by a free power turbine to a high pressure gas output by the higher pressure compressor.

22. An engine, comprising:
a combustor;
a fuel system operable to provide an amount of fuel to the combustor to provide a selected combustor output temperature;
a higher pressure spool having a higher pressure compressor, a higher pressure turbine, and a first rotatable shaft rotatably coupling the higher pressure compressor and the higher pressure turbine on a first pair of bearings wherein the higher pressure turbine delivers a first reduced pressure and temperature gas flow to one or more lower pressure spools;
one or more lower pressure spools, at least one of which has a lower pressure compressor and a lower pressure turbine rotatably connected by a second rotatable shaft;
a primary power takeoff from at least one of the higher pressure spool and one of the one or more lower pressure spools, wherein the power takeoff delivers a first power level;
a variable area nozzle upstream of a free power turbine, wherein the mass flow controlled by the variable area nozzle is a first mass flow to the free power turbine;
a combined motor and alternator device as part of the higher pressure spool operable, in a first mode, to drive the first rotatable shaft for starting the engine and, in a second mode, to convert rotational energy of the first rotatable shaft to electrical energy and, in a third mode, to free wheel; and
a control system operable to reduce power from the power takeoff from the first power level to a second lower power level while substantially providing at least one of a selected engine efficiency, a selected fuel-air ratio, a selected combustor exit temperature, a selected fuel consumption level of the engine and a selected higher pressure spool speed by using the variable area nozzle to reduce the first mass flow to a second lower mass flow and by operating the combined motor and alternator device in the second mode, wherein the inlet temperatures to the one or more lower pressure turbines are reduced below the inlet temperatures to the one or more lower pressure turbines when operating the combined motor and alternator device in the third mode.

23. The engine of claim 22 further comprising:
a combustor for receiving a gas flow from the higher pressure compressor; and;
a free turbine spool comprising the free turbine and a free turbine shaft, the free turbine shaft rotatably coupling the free turbine to the load device, the load device being a least one of a mechanical load and an electrical load.

24. The engine of claim 23, wherein the load device is connected to the free turbine, the load device being at least one of an alternator and a geared transmission and wherein the engine further comprises an intercooler positioned between the higher pressure compressor and the lower pressure compressor and a recuperator positioned to transfer heat from an exhaust gas output by the free turbine spool to a high pressure gas output by the higher pressure compressor.

25. A method, comprising:
(a) providing a gas turbine engine comprising a combustor, one or more turbo-compressor spools, at least one power turbine, a combined motor and alternator device in mechanical communication with the one or more turbo-compressor spools, and a variable area nozzle positioned upstream of the at least one power turbine, wherein, during a first time interval, a first rate of fuel flow is to the combustor and a first rate of mass flow of the combusted gas exits the combustor;
(b) during a second time interval, reducing a first rate of fuel flow to the combustor to a second rate of fuel flow to the combustor, the first rate of fuel flow being greater than the second rate of fuel flow;
(c) during the second time interval, reducing, by the variable area nozzle, a first rate of mass flow of the combusted gas exiting the combustor to a second rate of mass flow of the combusted gas existing the combustor, the first rate of mass flow being greater than the second rate of mass flow; and
(d) during the second time interval, extracting electrical energy with the combined motor and alternator device operating in an electrical energy generating mode, thereby reducing the inlet temperatures to the one or more lower pressure turbines below the inlet temperatures to the one or more lower pressure turbines when operating the combined motor and alternator device in the third mode.

26. The method of claim 25, wherein the generator device is a combined motor and alternator device and further comprising:
the step of imparting rotation including electrically coupling the combined motor and alternator device to a power supply of a vehicle.

27. The method of claim 26, wherein the generator device is a combined motor and alternator device and wherein, during engine operation, the generator device extracts less than about 10% of the full power rating of the engine.

28. A method, comprising:
providing a gas turbine engine comprising a combustor, one or more turbo-compressor spools, at least one power turbine, a generator device in mechanical communication with the one or more turbo-compressor spools, and a variable area nozzle positioned upstream of the at least one power turbine, wherein, during a first time interval, a first rate of fuel flow is to the combustor and a first rate of mass flow of the combusted gas exits the combustor;
during a second time interval, reducing a first rate of fuel flow to the combustor to a second rate of fuel flow to the combustor, the first rate of fuel flow being greater than the second rate of fuel flow;
during the second time interval, reducing, by the variable area nozzle, a first rate of mass flow of the combusted gas exiting the combustor to a second rate of mass flow of the combusted gas existing the combustor, the first rate of mass flow being greater than the second rate of mass flow; and
during the second time interval, extracting electrical energy with the generator device operating in an electrical energy generating mode, thereby maintaining the speed of one or more turbo-compressor spools below a selected value.

29. A method, comprising:
providing a gas turbine engine comprising a combustor, a fuel system, a control system, one or more turbo-compressor spools, at least one power turbine, a motor/generator device in mechanical communication with the one or more turbo-compressor spools, and a variable area nozzle positioned upstream of the at least one power turbine, wherein, during a first time interval, the following is true:
a first power is output by the at least one power turbine;
a first rate of fuel flow is sent to the combustor by the fuel system;
a first rate of mass flow is controlled by the variable area nozzle;
a first amount of auxiliary power is extracted from the motor/generator device wherein the first amount of auxiliary power may be zero;
the combusted gas exits the combustor at a selected combustor output temperature; and
an engine efficiency is established by maintaining a selected combustor output temperature;
and wherein, during a second time interval, the following is true:
a second power is output by the at least one power turbine, the second power output being less than the first power output;
a second rate of fuel flow is sent to the combustor by the fuel system, the second rate of fuel flow being less than the first rate of fuel flow
a second rate of mass flow is controlled by the variable area nozzle, the second rate of mass flow being less than the first rate of mass flow; and
a second amount of auxiliary power is extracted from the motor/generator device wherein the second amount of auxiliary power is greater than the first amount of auxiliary power.

30. The method of claim 29 wherein, during a second time interval, the following is also true:
the second rate of mass flow, the second rate of fuel flow and the second amount of auxiliary power extracted from the motor/generator device are varied to substantially maintain the selected combustor output temperature;
a selected rpm threshold of one or more turbo-compressor spools is not exceeded; and
a selected input temperature threshold of the one or more turbo-compressor spools is not exceeded.

31. The method of claim 30, further comprising:
the step of imparting rotation including electrically coupling the motor/generator device to a power supply of a vehicle; and
after starting the gas turbine engine, using the motor/generator device to convert rotational energy of the rotatable shaft to electrical energy.

32. The method of claim 30, wherein the motor/generator device is combined motor and alternator device and wherein, during engine operation, the motor/generator device extracts less than about 10% of the full power rating of the engine.
